(19) United States
(12) Patent Application Publication
(10) Pub. No.: US 2011/0246977 A1
(43) Pub. Date: Oct. 6, 2011

(54) CONTROL SYSTEM CODE INSTALLATION AND UPGRADE

(75) Inventors: Kevin Parsons, Wilsonville, OR (US); Subramanian Muthu, Portland, OR (US); David E. Burgess, Beaverton, OR (US); Richard A. Leinen, Wilsonville, OR (US)

(73) Assignee: LEVITON MANUFACTURING CO., INC., Melville, NY (US)

(21) Appl. No.: 12/751,942

(22) Filed: Mar. 31, 2010

(51) Int. Cl. G06F 9/44; G06F 15/16

(52) U.S. Cl. 717/171; 709/227

(57) ABSTRACT

A system including multiple control system devices. The control system devices include a processor; a memory coupled to the processor and configured to store code for the control system device; and a communication interface coupled to the processor. A control system device is configured to receive updated code corresponding to at least one of the control system devices, and configured to transmit the updated code to the corresponding at least one of the control system devices.

### BACKGROUND

This disclosure relates to control system code and, in particular, to the installation and upgrade of code within the control system.

Control systems can have a variety of components, each with its own associated code. For example, a lighting control system can include switches, sensors, power packs, or the like, located at both central and distributed locations. Such components can be installed in relatively inaccessible locations, such as within walls. To upgrade any code within these components, the component must be uninstalled and returned to the manufacturer.

### BRIEF DESCRIPTION OF THE DRAWINGS

FIG. 1 illustrates an embodiment of a control system having upgradable code according to some of the inventive principles of this patent disclosure.

FIG. 2 illustrates an embodiment of a device in the control system of FIG. 1 according to some of the inventive principles of this patent disclosure.

FIG. 3 illustrates another embodiment of a device in the control system of FIG. 1 according to some of the inventive principles of this patent disclosure.

FIG. 4 illustrates another embodiment of a device in the control system of FIG. 1 according to some of the inventive principles of this patent disclosure.

FIG. 5 illustrates an embodiment of updating code in a control system according to some of the inventive principles of this patent disclosure.

FIG. 6 illustrates another embodiment of updating code in a control system according to some of the inventive principles of this patent disclosure.

FIG. 7 illustrates an embodiment of installing a control system according to some of the inventive principles of this patent disclosure.

FIG. 8 illustrates an embodiment of a lighting control system having upgradable code according to some of the inventive principles of this patent disclosure.

### DETAILED DESCRIPTION

Some of the inventive principles of this patent disclosure relate to the installation and upgrade of control system code.

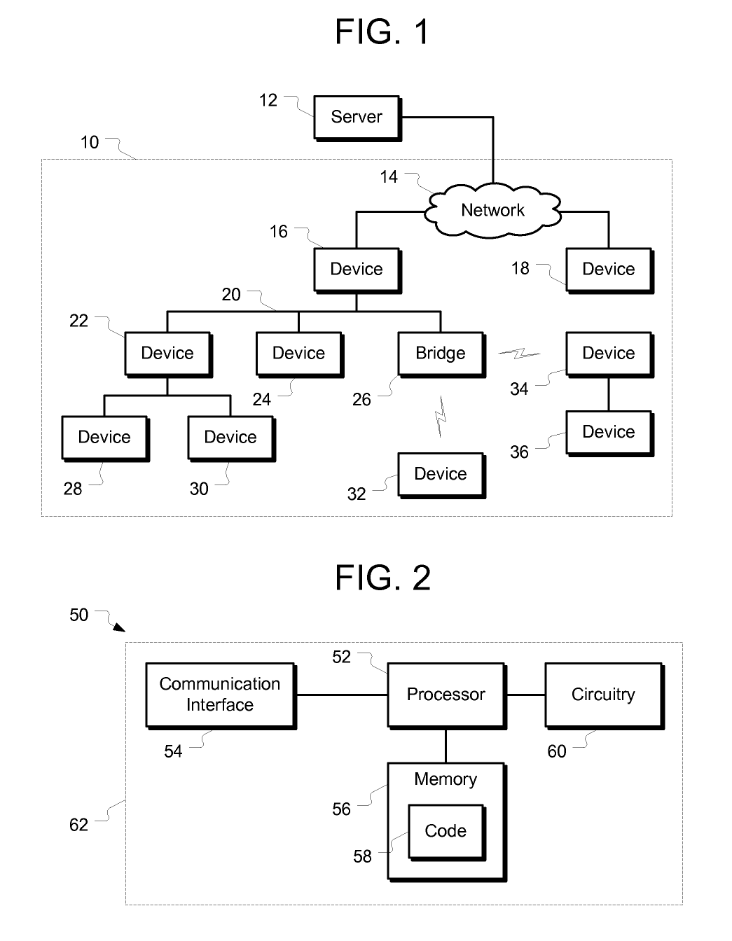

FIG. 1 illustrates an embodiment of a control system having upgradable code according to some of the inventive principles of this patent disclosure. The control system 10 can include a variety of control systems. The control system 10 can include multiple devices. For example, the control system 10 can include a lighting control system. The various devices can include lighting controls, switches, relays, sensors, or the like. In another embodiment, the control system 10 can include a heating, ventilation, air conditioning (HVAC) system. The devices can include fans, compressors, heat exchangers, valves, or the like. Any control system 10 with distributed devices can be used.

The devices are coupled together through a variety of communication links. In this embodiment, the control system 10 includes a network 14. Devices 16 and 18 are coupled to the network 14. Devices 16 and 18 can be configured to communicate with each other through the network 14. As will be described in further detail below other devices of the control system 10 can be configured to communicate in other ways.

In this embodiment, the network 14 is coupled to a server 12. The server 12 can be part of the control system 10, or can be separate, such as a server of a manufacturer, distributor, retailer, or the like. At least one device is coupled to the server 12. In this embodiment, devices 16 and 18 are coupled to the server 12 through the network 14.

FIG. 2 illustrates an embodiment of a device in the control system of FIG. 1 according to some of the inventive principles of this patent disclosure. The device 50 is an example of the various devices of FIG. 1. In this example, the device 50 includes a processor 52, a communication interface 54 coupled to the processor 52, and a memory 56 coupled to the processor 52. The processor 52 can include any variety of circuitry. In embodiment, the processor 52 can include digital circuitry such as general purpose processors, digital signal processors, programmable logic devices, application specific integrated circuits, or the like. Any such circuitry and/or logic can be used to implement the processor 52 in analog and/or digital hardware, software, firmware, etc., or any combination thereof.

The communication interface 54 can include any variety of interfaces. For example, the communication interface 54 can include a serial interface, a parallel interface, a wired or wireless interface, a radio frequency interface, an optical interface, or the like. The communication interface 54 can include an Ethernet interface, a Bluetooth interface, a controller area network interface, or any other interface.

The memory 56 can include any variety of memory. For example, the memory can include dynamic memory, static memory, random access memory, flash memory, or the like.

Any memory that can be written to more than once can be used. However, in an embodiment, other memory, such as read only memories, can also be included in the memory 56.

In an embodiment, the memory 56 can be configured to store code 58. As used here, code can include any instructions in any format, whether machine or human readable, compiled or interpreted, or the like. For example, the code 58 can include source code, machine code, object code, or any combination of such code. The code 58 can enable the device 50 to perform particular functions. As will be described in further detail below, the code 58 can be updated. However, the code 58 can include portions that are stored in read only memories, hardcoded, or the like. Moreover, within a device 50, the code can be distributed in various circuitry. For example, a device can include both a general purpose processor with associated code and a digital signal processor with different associated code. The code for the circuitry can be stored in one location, but can still be referred to as the code 58 or part of the code 58.

The device 50 can also include circuitry 60. For example, if the device 50 is a relay module for controlling a lighting load, a relay can be part of the circuitry 60. In another example, if the device 50 is a sensor, such as an occupancy sensor, the circuitry 60 can include the sensing circuitry.

Regardless of the type of circuitry 60, the code 58 can enable functionality of the device 50 when the processor interacts with the circuitry 60. For example, the code 58 can include instructions that manipulate sensed data from an occupancy sensor to make a determination of whether an occupant is present. In another example, the code 58 can include instructions that control the action of a relay.

Referring to FIGS. 1 and 2, the device 50 can be used as one of the various devices of the control system 10. For example, the device 16 can be the device 50 where the communication interface 54 can connect with the network 14. Through the communication interface 54, the device 50 can receive updated code. The updated code can include code for the device 50. In addition, the updated code can also include code for one or more of the other devices of the control system 10.

In an embodiment, the device 16 can be configured to transmit the updated code to the other devices. For example, the device 16 can transmit the updated code, whether the entire update or a corresponding portion, to the device 18 through the network 14.

As described above, a server 12 can be coupled to the network 14. In an embodiment, the device 16 can receive the updated code from the server 12. The server 12 can provide the updated code in a variety of ways. For example, the server 12 can be a file transfer protocol (FTP) server from which the device 16 can retrieve the updated code. In another example, the server 12 can provide a web interface through which the device 16 can obtain the updated code.

In an embodiment, the code can be obtained by request. For example, the device 16 can communicate with the server 12 requesting the updated code. In response, the server 12 can transmit the updated code to the device 16. The device 16 can be configured to periodically check for updates from the server 12.

In another embodiment, the updated code can be delivered to the device 16 without a request. For example, the server 12 can periodically communicate with the device 16 to provide updates. In another example, the server 12 can identify updated code, whether for one device or multiple devices of the control system 10, and deliver that update to the device 16. In yet another example, the server 12 can be instructed to deliver the updated code to the device 16. Although the updated code has been described as being received from the server 12, as will be described in further detail below, the updated code can be obtained in other ways.

Regardless of how obtained, the device 16 can then distribute the updated code to the other devices, such as device 18. In an embodiment, the device 16 can be configured to receive the updated code for each device in the control system 10. Within the control system 10, the device 16 can be a single point of contact for updates for the entire control system 10. The other device, such as device 18, can, but need not, be capable of communicating with the server 12, or having other ways of obtaining the updated code. As the devices can include communication interfaces coupled to the device 16, whether directly or indirectly, the updated code can be communicated to the various other devices from the device 16.

In an embodiment, the device 50 can be substantially encapsulated within a housing 62. For example, the housing 62 can be a cabinet. In another embodiment, the housing can be an electrical wall box. In another embodiment, the housing 62 can be a case.

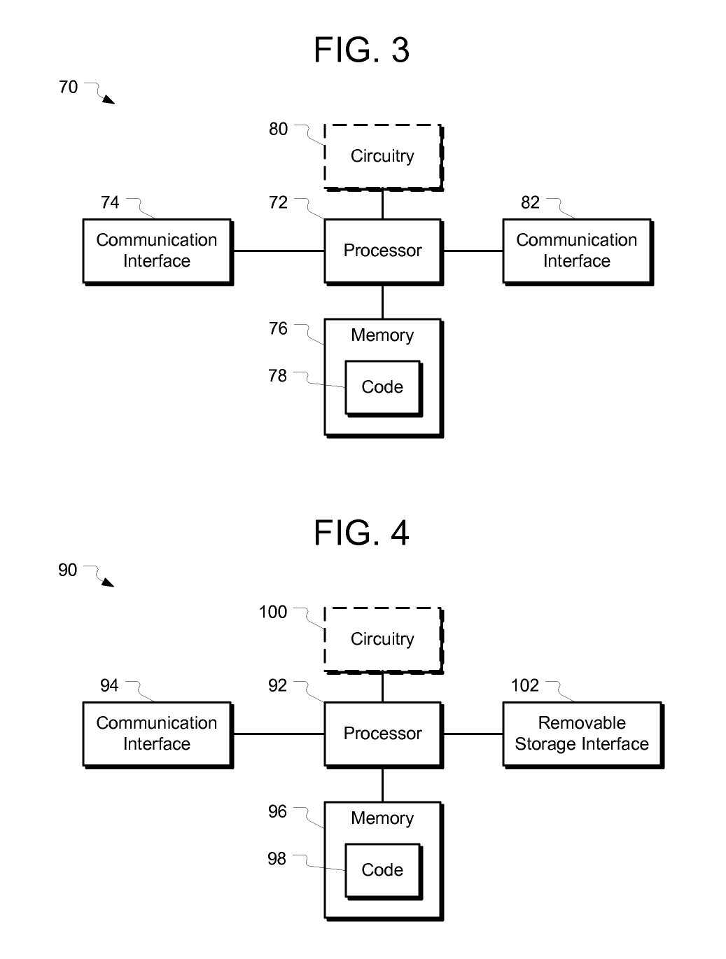

FIG. 3 illustrates another embodiment of a device in the control system of FIG. 1 according to some of the inventive principles of this patent disclosure. Although one communication interface was described above, a device 70 can have multiple communication interfaces, such as interfaces 74 and 82. These communication interfaces can be the same or different types of interfaces. Although two communication interfaces 74 and 82 have been illustrated, the device 70 can include any number of such interfaces. Referring to FIGS. 1 and 3, the device 70 could be used as the device 16. The device 16 can be coupled to a network 20, such as a controller area network (CAN), a local area network, a serial communication link, or the like. The device 16 can receive the updated code through the network 14 as described above. The device 16 can then transmit the updated code through the network 20 to devices 22 and 24, the bridge 26, or the like.

As described above, the device 18 can receive the updated code from the device 16 through the network 14. That is, the device 18 received the updated code through the same network 14 as device 16, albeit from a different source. In an embodiment, the device 18 could have received the updated code directly from the server 12, similar to device 16. However, in an embodiment, devices 22 and 24 may not be capable of communication with the server 12. However, the devices 22 and 24 can still receive the updated code through the device 16.

In an embodiment, the device 70 can have circuitry 80 similar to circuitry 60 described above. However, in another embodiment, the device 70 may not have such circuitry 80. For example, the device 70 could span communication networks. The bridge 26 is an example of such a device. The bridge 26 spans the network 20 and a wireless network coupling the bridge 26 and devices 32 and 34. The bridge 26 can also include code that can be updated, just as other devices in the control system 10. Although a wireless network has been described as a network associated with the bridge 26, the networks can be any variety as described above.

Moreover, the devices 34 and 36 illustrate that the devices can be coupled with a variety of communications links. The updated code can be transmitted along these links, through various intervening devices, or the like. For example, updated code from device 16 can be transmitted through network 20 and bridge 26 to device 34. Device 34 can then transmit the updated code to the device 36.

In an embodiment, a device may be a master device coupled to one or more slave devices. For example, device 22 can be a master device for slave devices 28 and 30. The updated code can include code for both the device 22 and the slave devices 28 and 30. The master device 22 can be responsible for distributing the adapted code to the slave devices 28 and 30.

FIG. 4 illustrates another embodiment of a device in the control system of FIG. 1 according to some of the inventive principles of this patent disclosure. In this embodiment, the device 90 includes a processor 92, a communication interface 94, and a memory 96 similar to devices 50 and 70 described above. However, the device 90 also includes a removable storage device interface 102. The removable storage device interface 102 can be any variety of interfaces. For example, the removable storage device interface 102 can be a universal serial bus (USB) port, a flash card interface, IEEE 1394 interface, or the like. In another example, the removable storage device interface 102 can be a compact disk/digital video disk drive, a floppy disk drive, or the like. In yet another example, the removable storage device interface 102 can be an interface for a hot-swappable mass storage device.

In an embodiment, the device 90 can receive the updated code through the removable storage interface 102. For example, a USB storage device can be coupled to the device 90. The device 90 can detect the attachment of the USB storage device. In response, the device 90 can examine the USB storage device to determine if an update is available. For example, updated code can be stored in a particular predefined location, directory, or the like in the USB storage device. The device 90 can search that location for updated code.

In another embodiment, the device 90 can be controlled to retrieve the updated code. For example, a user can indicate where on the USB storage device the updated code is stored. A user can activate a user interface, such as a button, keypad, or the like, to instruct the device 90. In another embodiment, the device 90 can be instructed by a user through the communication interface 94. Regardless, the device 90 can receive the updated code from an attached storage media.

In particular, in an embodiment, a server 12 described above is not needed. That is, the control system 10 can be a stand alone system without access to a server 12. Updated code can be provided on a removable storage medium to the control system 10.

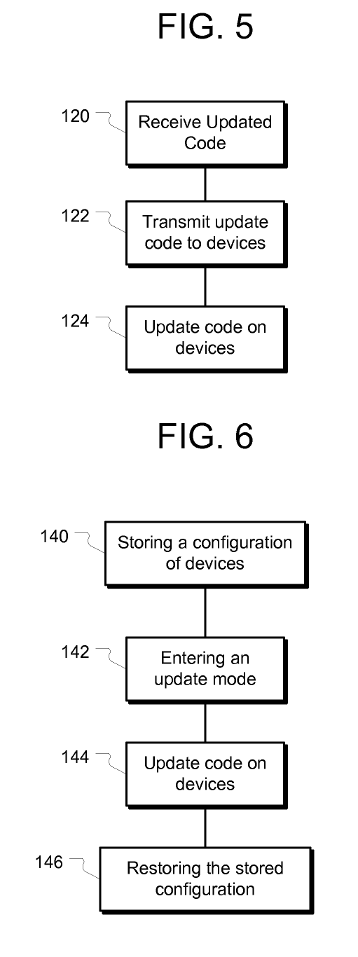

FIG. 5 illustrates an embodiment of updating code in a control system according to some of the inventive principles of this patent disclosure. As described above, a variety of techniques can be used to obtain the updated code. Accordingly, receiving the updated code in 120 can include, retrieving the updated code from a server 12, identifying the updated code in a removable storage device, or the like. Regardless of the source, a device can receive the updated code.

In 122 the device can transmit the updated code to other devices within the control system. In an embodiment, the entire updated code can be transmitted to each device. Each device can then use the updated code, a portion of the updated code, or the like as appropriate.

In another embodiment, the device can transmit the appropriate portions of the updated code to the devices. For example, the device can communicate directly with the other devices to supply the updated code. In another example, the device can forward the updated code or an appropriate portion to another device. The other device can deliver the corresponding updated code to its associated devices.

Referring to FIG. 1, for example, device 18 may have multiple associated devices (not illustrated). Device 16 can receive the updated code and transmit the appropriate portion to device 18. Device 18 can then handle the distribution and update of its associated devices. Such an update can occur while device 16 is performing other updates. Accordingly, the updating of code can be distributed across the control system 10.

In another embodiment, the device can transmit the updated code to a subset of devices. For example, the device can transmit the updated code using a multicast or broadcast address. For example, the device 16 of FIG. 1 can transmit the updated code using a broadcast address over network 20. Thus, the devices 22 and 24, and the bridge 26 can receive the updated code substantially simultaneously.

In another embodiment, a multicast address can be used that is associated with a group of devices. For example, devices 22 and 24 can be similar devices. Thus, devices 22 and 24 can form a group. This group can be distinct from the bridge 26. Devices 22 and 24 can be associated with a particular multicast address associated with the group. Accordingly, the code can be transmitted to the devices of the group substantially simultaneously using the multicast address. Other groups of devices can be configured to listen on different multicast addresses to receive their corresponding portion of the updated code. By transmitting the code over the multicast address, the entire updated code need not be delivered to each device. Although multicast and broadcast have been described above, broadcast can be used to refer to a multicast transmission as the transmission is broadcast to the associated group.

Referring to FIG. 5, once a device has its updated code, in 124 the code on that device can be updated. In an embodiment, the update can occur substantially simultaneously. That is, the code can be delivered then, once each device has its associated code, the update can be initiated. However, in another embodiment, the update can be performed sequentially, in groups, or in a combination of such techniques.

In an embodiment, a single device can receive the updated code. The updated code can include updated code for that particular device. The device can update itself in response to the updated code. The updated device can then update the other devices in the control system, the devices in its local group, or the like.

As described above, a master device can include multiple slave devices. The master device can receive the updated code. The master device can then transmit the updated code to the slave devices. Such a hierarchy can be repeated with the slave devices acting as master devices for associated slave devices.

FIG. 6 illustrates another embodiment of updating code in a control system according to some of the inventive principles of this patent disclosure. In 140, a configuration of the devices of the control system can be stored. For example, the configuration can be stored in a database, stored in a local or remote storage device, or the like. In another embodiment, the configuration can be stored on a device level. That is, each device can store its configuration in a local memory or other storage device. The stored configuration can, but need not, be an entire configuration of the control system. For example, for a lighting control system, the configuration can include the states of loads, scenes, or the like.

Once the configuration is stored, the devices can be placed in an update mode in 142. In the update mode, the functionality of the devices can be limited. In a particular example, the update mode can be substantially similar to an emergency mode as if the control system had lost power. For example, relays for emergency circuits can be closed while other relays can be opened. In another example, all circuits can be activated. In another example, particular circuits or functionality can be disabled. The functionality of the devices in the update mode can be selected as desired.

While in the update mode, the code on the devices can be updated in 144. As described above, the code can be delivered and updated in a variety of ways. Accordingly, the update of the code in 144 can be similarly as varied.

Once the update is complete, the configuration of the devices can be restored in 146. For example, the stored configuration can be read from a database and used to reconfigure the devices. In another example, each device can retrieve its own stored configuration and configure itself.

As part of the update process, the previous version of the code can be stored as a backup. In addition, other information concerning the update process can be recorded, logged, or the like. For example, a number of attempts at updating a device can be recorded. Such a record or the logging can be preformed by individual devices, a device that receives the updated code, or the like.

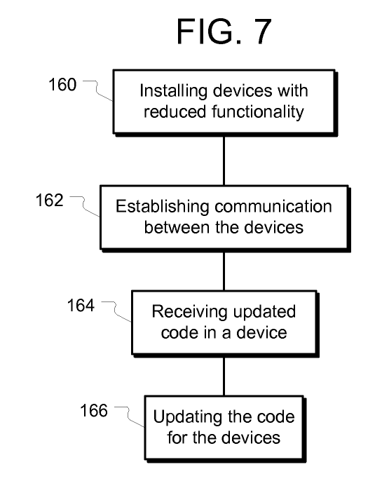

FIG. 7 illustrates an embodiment of installing a control system according to some of the inventive principles of this patent disclosure. In this embodiment, devices can be installed in 160 with a reduced functionality. For example, the code stored in a device may provide less than all of the functions that the device is capable of performing. In another example, code may not be present to interface with the circuitry of the device.

Such code can be referred to as basecode. In an embodiment, the basecode can allow a processor of a device to communicate through a communication interface, identify the device, and perform some limited operations. For example, the basecode can allow the device to receive updated code and update itself.

Accordingly, after being installed, the devices can establish communication with each other in 162. As a result, the infrastructure to distribute updated code is installed. However, the updated code that can implement the system need not be present and can be installed at a later time.

In 164, updated coded can be received and the devices updated in 166. For example, immediately after completing installation, the code for the devices can be updated. In another example, the code can be updated when the control system is to be activated. As a result, the control system can be configured when desired and with the desired code.

In an embodiment, devices with the basecode can be shipped and installed. Such installation can occur at any time before, during or after operational code is available. Thus the devices can be manufactured and installed without having the operational code. The time taken for manufacturing and installation can be used in parallel to develop the operational code, develop more features, or the like.

Even if updated code has become available, the manufacturing of the devices need not change, version numbers need not be updated, and other code related tracking need not be performed. That is, devices manufactured before operational code was even available need not be restocked as the basecode allows the device to be updated when desired.

In an embodiment, the limited functionality of the basecode can establish communication with other devices. For example, the basecode can establish a unique address for the device. This can be hardcoded into the device, dynamically assigned, discovered from the environment, or the like. In an embodiment, the address can be unique among the devices, unique among groups of devices, or the like. That is, the basecode may only respond to a multicast address and not have a unique address that distinguishes it from another device. However, after an update, the updated code can cause the device to acquire a unique address or communicate differently as desired.

In addition, the basecode can identify the device. In an embodiment, the basecode can be configured to allow the device to identify itself. Accordingly, the device can be interrogated by another device, such as a device that as received the updated code, and can receive the appropriate updated code from that device. In another embodiment, the identification can be implicit within the associated multicast address. That is, without knowing what devices are available, a device can receive the updated code, then broadcast the code on the appropriate multicast addresses. A device with basecode associated with a particular multicast address can then receive that updated code.

In an embodiment, the basecode can have no functionality beyond the amount needed to communicate and update the code. Thus, other operations that a device may be configurable to perform cannot be performed with the basecode alone. In an embodiment, the updating of code in the devices can be a multi-stage process. That is, one level of devices may not be configured to be aware of associated, yet existing devices. Once updated, the devices may be capable of recognizing the associated devices and updating their corresponding basecode.

In another embodiment, the basecode can provide some limited functionality. For example, the basecode can place the device in the update mode, an emergency mode, or the like as described above.

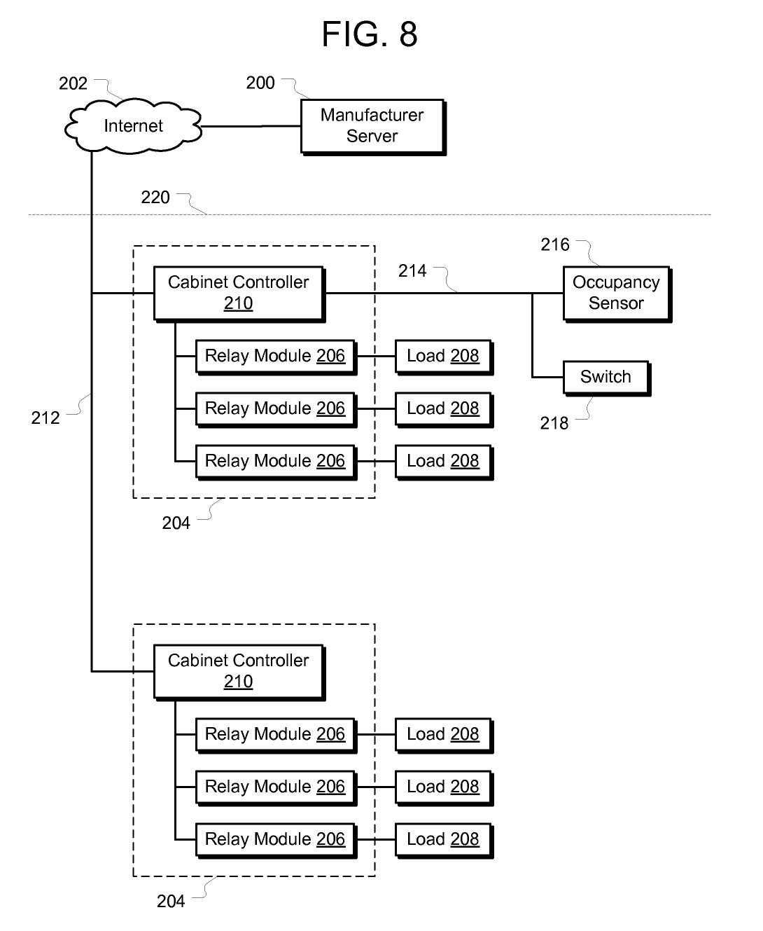

FIG. 8 illustrates an embodiment of a lighting control system having upgradable code according to some of the inventive principles of this patent disclosure. In this embodiment, a lighting control system 220 includes relay cabinets 204, each with relay modules 206 that are configured to control power to associated loads 208. The loads 208 can be electrical loads, such as a light, a fan, an outlet, or any other electrical circuit can be controlled.

Each relay cabinet 204 can include a cabinet controller 210. The relay cabinets 204 can be coupled to a network 212 that can be coupled to the Internet 202, or another network. A manufacturer server 200 is also coupled to the Internet 202 or other network.

In this embodiment, one relay cabinet 204 is coupled to an occupancy sensor 216 and a switch 218 through a communication network 214. The lighting control system 220 can include other cabinets, sensors, loads, switches, or the like beyond those illustrated.

The cabinet controller 210, relay modules 208 occupancy sensor 216, switch 218, and any other devices can be the devices described above. That is, each can include a processor and memory that establishes some functionality for the device. The code for those devices can be updated as described above. Moreover, some or all of the lighting control system 220 can be installed with devices having the basecode as described above. That is, the installation of the lighting control system 220 need not wait until the operational code for the devices in the lighting control system 220 is available.

The inventive principles of this patent disclosure have been described above with reference to some specific example embodiments, but these embodiments can be modified in arrangement and detail without departing from the inventive concepts. For example, some of the embodiments have been described in the context of lighting control systems, but the inventive principles apply to other types of control systems as well. Any of the circuitry and logic described herein may be implemented in analog and/or digital hardware, software, firmware, etc., or any combination thereof. Such changes and modifications are considered to fall within the scope of the following claims.

1. A control system comprising:
a plurality of control system devices, each control system device including:
a processor;
a memory coupled to the processor and configured to store code for the control system device; and
a communication interface coupled to the processor;
wherein a first control system device of the control system devices is configured to receive updated code corresponding to at least one of the control system devices, and configured to transmit the updated code to the corresponding at least one of the control system devices.

2. The control system of claim 1, wherein the first control system device is configured to receive updated code for each of the control system devices.

3. The control system of claim 2, wherein the first control system device is configured to update the code for the first control system device.

4. The control system of claim 3, wherein the first control system device is configured to update the code for the first control system device before transmitting the updated code to the corresponding at least one of the control system devices.

5. The control system of claim 1, wherein a second control system device of the control system devices is configured to receive the updated code from the first control system device and transmit the updated code to at least one slave control system device of the second control system device.

6. The control system of claim 1, wherein the first control system device further comprises:
a removable storage device interface; and
the first control system device is configured to query a removable storage device for the updated code when attached to the removable storage device interface.

7. A method comprising:
receiving updated code in a first control system device of a plurality of control system devices, the updated code including code for at least one of the control system devices;
transmitting the updated code to the at least one of the control system devices; and
updating the code in the control system devices in response to the updated code.

8. The method of claim 7, further comprising:
recognizing an attachment of a removable storage device to the first control system device; and
transferring the updated code from the removable storage device to the first control system device.

9. The method of claim 8, further comprising:
searching a predefined location in the removable storage device for the updated code.

10. The method of claim 7, further comprising:
updating each of the control system devices with a corresponding part of the updated code.

11. The method of claim 7, further comprising:
broadcasting a part of the updated code associated with a group of the control system devices to the group of the control system devices.

12. The method of claim 7, further comprising:
broadcasting the updated code to the control system devices.

13. The method of claim 7, further comprising:
receiving the updated code from the first control system device in a master control system device; and
transmitting the updated code to slave control system devices of the master control system device.

14. The method of claim 7, further comprising:
storing a configuration of the control system devices; and
for each control system device:
entering an update mode for the control system device;
updating code of the control system device in response to the updated code; and
restoring the stored configuration of the control system devices.

15. The method of claim 14, wherein entering an update mode for a control system device comprises disabling at least one function of the control system device.

16. A system comprising:
a plurality of control system devices, each control system device including:
a processor;
a memory coupled to the processor and configured to store a basecode for the control system device; and
a communication interface coupled to the processor;
wherein the basecode for each control system device is configured to cause the control system device to establish communication through the communication interface and identify the control system device, while at least some operations of the control system device are disabled.

17. The control system of claim 16, wherein a first control system device of the control system devices is configured to receive updated code and transmit the updated code to other control system devices of the control system devices.

18. The control system of claim 17, wherein the updated code enables at least one of the disabled operations of the control system device.

19. The control system of claim 16, wherein for at least one control system device:
the control system device includes circuitry; and
the basecode does not include code to actuate the circuitry.

20. A method comprising:
installing a plurality of control system devices, each control system device including a corresponding basecode that disables at least some operations of the control system device;
establishing communication between the control system devices;
receiving updated code in a first control system device of the control system devices; and
transmitting the updated code to the control system devices from the first control system device.

21. The method of claim 20, wherein transmitting the updated code comprises transmitting the updated code to a multicast address associated with a group of substantially similar control system devices of the control system devices.

22. The method of claim 20, further comprising:
updating code of the control system devices in response to the updated code;
wherein at least some of the disabled operations of the control system device are enabled in response to the updated code.

23. The method of claim 20, wherein the installation of the control system devices occurs prior to existence of the updated code.
